(19) United States
(12) Patent Application Publication
(10) Pub. No.: US 2008/0099253 A1
(43) Pub. Date: May 1, 2008

(54) Coordinate Detecting Apparatus, Display Apparatus and Coordinate Detecting Method

(75) Inventors: Kenichiro Ishikura, Nara (JP); Saburo Miyamoto, Kyoto (JP); Hiroshi Hamada, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, OSAKA-SHI, OSAKA, JAPAN (JP)

(21) Appl. No.: 11/666,122

(22) PCT Filed: Oct. 28, 2005
(86) PCT No.: PCT/JP05/19868

§ 371 Date: Apr. 24, 2007

(30) Foreign Application Priority Data
Oct. 29, 2004 (JP) 2004-316977

(51) Int. Cl. G06F 3/041

(52) U.S. Cl. 178/18.01

(57) ABSTRACT

In a panel (1a) of a touch panel (1), a coordinate axis x is set by connecting points A and B that are current observation points. When a designated point P is designated on the panel (1a), currents (i1) and (i2) corresponding respectively to a distance between the designated point P and the point A and a distance between the designated point P and the point B flow respectively to a resistive film between the points P and A and a resistive film between the points P and B by voltage sources (e1) and (e2), and a sum of these currents flows to an impedance Z connected to the designated point P. A coordinate x of the designated point P is calculated by detecting the currents (i1) and (i2).

### TECHNICAL FIELD

The present invention relates to a coordinate detecting apparatus and more particularly to a coordinate detecting apparatus which detects the position of a point on a display panel which point has been designated by an operator.

### BACKGROUND ART

Referring to FIG. 12, the following will explain a principle of detecting a coordinate on a conventional touch panel. FIG. 12 is a diagram showing the arrangement of the above conventional touch panel. The coordinate detection principle, explained below, relates to a capacitive coupling touch panel which detects the coordinates of a point on the panel which point is touched by a human body.

A touch panel 101 includes, for example, a rectangular panel 101a. Points A to D that are four corners of the panel 101a are connected to alternating voltage sources e1 to e4, respectively. Magnitudes, frequencies and phases of voltages of the voltage sources e1 to e4 are equal to each other. The panel 101a is made by forming, on a glass substrate or on a film substrate, a resistive film, such as, as a surface resistor, a carbon film, an ITO (Indium Tin Oxide) film, or a NESA (tin oxide) film. The operator touches with his/her finger the panel 101a so as to carry out a point designation. A point P shown in FIG. 12 is a point (hereinafter referred to as a “designated point”) designated by the operator. By the point designation carried out by the operator, the capacitive coupling between the human body and the resistive film is carried out at the designated point. In FIG. 12, the human body is shown by an impedance Z. With this, currents i1 to i4 flow respectively to the points A to D that are four corners of the panel 101a, and a current that is a sum of the currents i1 to i4 flows from a point (designated point) touched by the finer to the human body.

A distance between each of the points A to D that are four corners and the point P changes depending on the position of the point P on the panel 101a. As a result, a resistance value from each of the points A to D to the point P changes, and the magnitudes of the currents i1 to i4 change. Therefore, by detecting the magnitudes of the currents i1 to i4, it is possible to find the coordinates of the point P on the panel 101a. For example, as disclosed in Japanese Publication of Japanese Examined Application 19176/1989 (Tokukouhei 1-19176, published on Apr. 10, 1989, internationally published on Sep. 4, 1980) and Japanese Unexamined Patent Publication No. 43002/2001 (Tokukai 2001-43002, published on Feb. 16, 2001), conventionally, an x-coordinate and y-coordinate of the point P are calculated by Formula 1 below using the currents i1 to i4.

$$x = C 0 x + K 0 x \frac{i 2 + i 3}{i 1 + i 2 + i 3 + i 4} \\ y = C 0 x + K 0 y \frac{i 1 + i 2}{i 1 + i 2 + i 3 + i 4} \qquad [ Formula 1 ]$$

### In Formula 1, C0x and C0y are constants, and K0x and K0y are coefficients.

### DISCLOSURE OF INVENTION

In the above conventional coordinate detecting method, as is clear from Formula 1, the sum of the currents i1 to i4 is used as the denominator of the second term of the right side for obtaining the x-coordinate. Meanwhile, the sum of the currents i2 and i3 is used as the numerator of the second term of the right side. The currents i2 and i3 are currents respectively flowing to the points B and C lined up in a y-axis direction (that is a direction perpendicular to an x-axis). To obtain the y-coordinate, the sum of the currents i1 to i4 is used as the denominator of the second term of the right side. Meanwhile, the sum of the currents i1 and i2 is used as the numerator of the second term of the right side. The currents i1 and i2 are currents respectively flowing to the points A and B lined up in an x-axis direction (that is a direction perpendicular to a y-axis).

Here, the current flowing to each of observation points A to D by the point designation changes depending on a distance between the designated point and each of the observation points A to D. Specifically, the current flowing to the observation point increases as the distance between the designated point and the observation point decreases. Meanwhile, the current flowing to the observation point decreases as the distance between the designated point and the observation point increases. When the designated point P is located at the left end of the panel 101a, the distance between the designated point P and the observation point B and the distance between the designated point P and the observation point C are long, so that the magnitudes of the currents i2 and i3 are small. In a case where the designated point P moves to the right, on the panel 101a, in a horizontal direction along the x-axis direction, the distance between the designated point P and the observation point B and the distance between the designated point P and the observation point C decreases, so that the magnitudes of the currents i2 and i3 increase. In this case, the changes in the currents i2 and i3 denote the same tendency as each other. Specifically, when the current i2 is small, the current i3 is also small, and when the current i2 is large, the current i3 is also large.

Similarly, when the designated point P is located at the lower end of the panel 101a, the distance between the designated point P and the observation point A and the distance between the designated point P and the observation point B are long, so that the magnitudes of the currents i1 and i2 are small. In a case where the designated point P moves upward, on the panel 101a, in a vertical direction along the y-axis direction, the distance between the designated point P and the observation point A and the distance between the designated point P and the observation point B decreases, so that the magnitudes of the currents i1 and i2 increase. As with the above case, the changes in the currents i1 and i2 denote the same tendency as each other. Specifically, when the current i1 is small, the current i2 is also small, and when the current i1 is large, the current i1 is also large.

In an actual apparatus, there exists a wiring resistance between the observation point and a current detecting section. Normally, the resistance value of the wiring resistance is set to be adequately smaller than the resistance value of the resistive film. Therefore, when the distance between the designated point P and the observation point is long, the resistance value of the wiring resistance is adequately small as compared with the resistance value of the resistive film between the designated point P and the observation point. On this account, the wiring resistance does not influence the current value so much. However, when the designated point P is located at a peripheral portion, the distance between the designated point P and the observation point is short, so that the resistance value of the resistive film between the designated point P and the observation point is small. As a result, the resistance value of the wiring resistance relatively increases as compared with the resistance value of the resistive film between the designated point P and the observation point, it becomes unignorable, and the accuracy of observing the current value decreases. In addition, in the actual apparatus, there exist noises in circuits. Therefore, if the current value becomes small, S/N decreases, and the accuracy of observing the current value also decreases.

According to Formula 1, the currents i2 and i3 are used as the numerator to calculate the x-axis. Therefore, when the designated point P approaches to the right end, the accuracy of detecting the currents i2 and i3 decreases, and the accuracy of detecting the coordinates decreases. Moreover, the same is true for the coordinate calculation of the y-axis.

A conventional coordinate detecting apparatus have a problem in that the detection accuracy is low since the apparatus has to use the above low-accuracy current value to calculate the coordinates at the peripheral portion.

A conventional technology of avoiding the deterioration of the coordinate detection accuracy due to the decrease in the amount of current is disclosed in Japanese Unexamined Patent Publication No. 43002/2001 (Tokukai 2001-43002). In this method, voltages are applied to only two points among four current observation points which two points are located diagonally, and the remaining two points are disconnected. Connected points and disconnected points are switched in a time-divisional manner so that a potential gradient is generated only in a diagonal direction. The current flowing to the current observation point is divided into two, not four, so that the amount of current flowing to each point increases. Thus, the detection accuracy improves. However, a complicated circuit is required to switch connection points, and it is necessary to obtain the current value at high speed, so that an expensive processing apparatus is necessary.

In addition, Tokukai 2001-43002 is directed to a capacitive coupling coordinate detecting apparatus whose panel is in the shape of a concave parabola. Therefore, this cannot be utilized for a panel having the other shape, such as a rectangle. Further, in the case of combining the coordinate detecting apparatus and a display apparatus, since the top of the concave parabola panel projects more than the display area, there has been a problem in that the outer size of the display apparatus with the coordinate detecting apparatus cannot be reduced.

The present invention was made to solve the above problems, and an object of the present invention is to realize a coordinate detecting apparatus, a display apparatus and a coordinate detecting method each of which has a simple circuitry, is inexpensive and can carry out the coordinate detection accurately in a wide range of the panel.

In addition, an object of the present invention is to realize a coordinate detecting apparatus and a coordinate detecting method each of which can deal with various panel shapes.

Moreover, an object of the present invention is to realize a coordinate detecting apparatus and a display apparatus each of which can make areas other than a coordinate detection surface smaller.

To solve the above problems, a coordinate detecting apparatus of the present invention includes: a surface resistor which is provided on the panel and has a substantially rectangular shape; a plurality of current detecting means, connected respectively to connection points of an outer peripheral portion of the surface resistor, for detecting currents flowing through the connection points; and coordinate calculating means for, based on values of currents flowing through two of the current detecting means which are connected respectively to two connection points provided respectively on two sides of the outer peripheral portion of the surface resistor which two sides face each other, calculating a coordinate component of the designated point on an axis obtained by connecting the two connection points on the surface resistor.

Moreover, in the coordinate detecting apparatus of the present invention, the plurality of the current detecting means may be first, second, third and fourth current detecting means connected respectively to the connection points provided on four sides of the outer peripheral portion of the surface resistor; and based on (i) a current detected by the first current detecting means connected to one of two connection points provided respectively on two sides of the outer peripheral portion of the surface resistor which two sides face each other and (ii) a current detected by the second current detecting means connected to the other connection point, the coordinate calculating means may calculate a first coordinate component of the designated point on a first axis obtained by connecting the two connection points, and based on (i) a current detected by the third current detecting means connected to one of two connection points provided respectively on the other two sides of the outer peripheral portion of the surface resistor which two sides face each other and (ii) a current detected by the fourth current detecting means connected to the other connection point, the coordinate calculating means may calculate a second coordinate component of the designated point on a second axis obtained by connecting the two connection points.

Moreover, in the coordinate detecting apparatus of the present invention, the coordinate calculating means may assume two-dimensional output coordinate axes on the surface resistor, a sum of (i) a coordinate component, on one of the output coordinate axes, of the first coordinate component of the designated point and (ii) a coordinate component, on said one of the output coordinate axes, of the second coordinate component of the designated point may be a coordinate component on said one of the output coordinate axes, and a sum of (i) a coordinate component, on the other output coordinate axis, of the first coordinate component of the designated point and (ii) a coordinate component, on the other coordinate axis, of the second coordinate component of the designated point may be a coordinate component on the other output coordinate axis.

Moreover, in the coordinate detecting apparatus of the present invention, the first, second, third and fourth current detecting sections may be connected respectively to the connection points at four peaks of the surface resistor.

Moreover, in the coordinate detecting apparatus of the present invention, the coordinate calculating means may assume a two-dimensional rectangular output coordinate system on the surface resistor, and calculate coordinates, on the two-dimensional rectangular output coordinate system, of the designated point based on the first coordinate component and the second coordinate component.

Moreover, in the coordinate detecting apparatus of the present invention, the first, second, third and fourth current detecting means may be connected respectively to the connection points each located on a vicinity of a median point of each of the four sides of the outer peripheral portion of the surface resistor.

Moreover, in the coordinate detecting apparatus of the present invention, the plurality of the current detecting means may be first, second and third current detecting means connected respectively to the connection points provided at three of four peaks of the surface resistor; and based on the first current detecting means and the second current detecting means which are connected respectively to two connection points provided respectively at both ends of one side of the outer peripheral portion of the surface resistor, the coordinate calculating means may calculate a first coordinate component of the designated point on a first axis obtained by connecting the two connection points, and based on the first current detecting means and the third current detecting means which are connected respectively to two connection point provided respectively at both ends of the other side adjacent to said one side of the outer peripheral portion of the surface resistor, the coordinate calculating means may calculate a second coordinate component of the designated point on a second axis obtained by connecting the two connection points.

Moreover, the coordinate detecting apparatus of the present invention may further include a resistor which is provided around the surface resistor, and has a resistance value lower than a surface resistance value of the surface resistor.

Moreover, in the coordinate detecting apparatus of the present invention, the current flowing through the connection point of the surface resistor may be a current by transfer of electric charge generated by light irradiation.

The present invention is directed to not only to a coordinate detecting apparatus but also to a display apparatus including the coordinate detecting apparatus and to a coordinate detecting method.

The coordinate detecting apparatus of the present invention is arranged so that, as above, the coordinates of the designated point are detected in such a manner that (i) each coordinate axis set on the panel is formed by connecting two points selected from the above current observation points and facing each other, and (ii) the coordinate components of the designated point on the coordinate axes are detected by using only the currents flowing through the above two current observation points on the axis among the currents flowing through a plurality of current observation points.

With this, it is possible to realize a coordinate detecting apparatus which can carry out the coordinate detection accurately in a wide range of the panel.

Moreover, since additional means other than current detecting means and coordinate calculating means which are at least essential for the coordinate detection is not required, it is possible to realize a coordinate detecting apparatus which has a simple circuitry, is inexpensive and can carry out the coordinate detection accurately.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 shows an embodiment of the present invention, and is a block diagram showing an arrangement of a main part of a touch panel.

FIG. 2 is a circuit diagram of the touch panel shown in FIG. 1.

FIG. 3 is an equivalent circuit diagram of the circuit diagram shown in FIG. 2.

FIG. 4 is another circuit diagram of the touch panel shown in FIG. 1.

FIG. 5 is an equivalent circuit diagram of FIG. 4.

FIG. 6 shows another embodiment of the present invention, and is a block diagram showing an arrangement of a main part of the touch panel.

FIG. 7 is a diagram for explaining coordinate axes set in a panel of the touch panel shown in FIG. 6.

FIG. 8 is a block diagram showing an arrangement of a main part of a first modification example of the touch panel shown in FIG. 6.

FIG. 9 is a block diagram showing an arrangement of a main part of a second modification example of the touch panel shown in FIG. 6.

FIG. 10 is a plan view showing an arrangement of a touch panel which is provided with a low resistive film around an outermost circumference thereof.

FIG. 11 shows a conventional technology, and is a block diagram showing an arrangement of a main part of a touch panel.

FIG. 12 is a block diagram showing one example in which a touch panel and coordinate calculating means are connected to each other.

FIG. 13 is a flow chart showing a flow of calculation by the coordinate calculating means.

### BEST MODE FOR CARRYING OUT THE INVENTION

### Embodiment 1

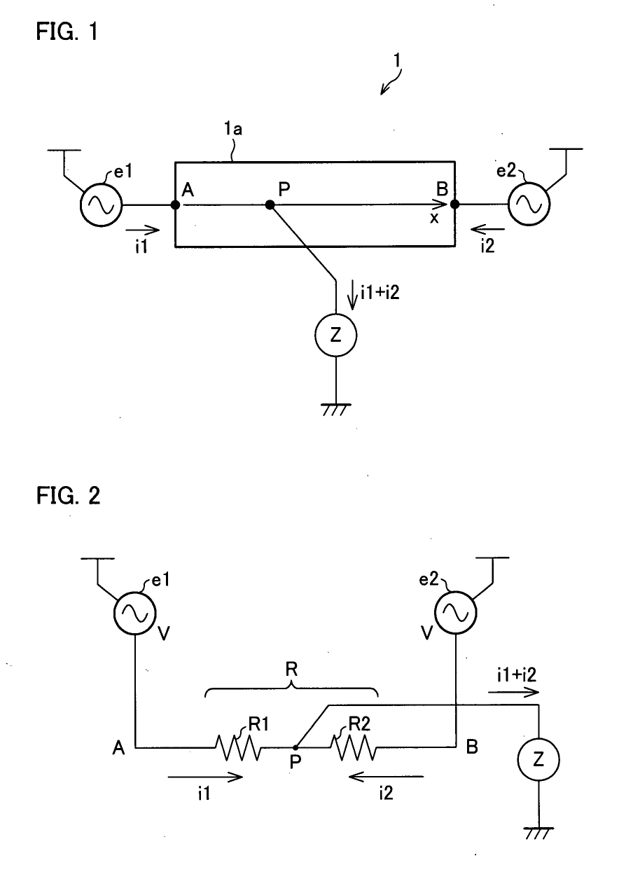

The following will explain one embodiment of the present invention on the basis of FIGS. 1 to 5.

FIG. 1 shows an arrangement of a touch panel 1 that is a coordinate detecting apparatus of the present embodiment. The touch panel 1 is a capacitive coupling touch panel, and includes a panel 1a that is a resistor which is linear or is in the shape of a strip whose width is adequately narrow. Points A and B located respectively on end-portion sides facing each other in a horizontal direction of the panel 1a are connected respectively to voltage sources e1 and e2 each of which generates an alternating voltage V (in the following explanation, the end portion of the panel indicates an end portion of a region that is a target of the coordinate detection). The magnitudes, frequencies and phases of the voltages V of the voltage sources e1 and e2 are equal to each other.

The panel 1a is made by forming a resistive film (such as a carbon layer, an ITO (Indium Tin Oxide) film, or a NESA (tin oxide) film) on a linear resistor or a substrate which is in the shape of a strip whose width is adequately narrow. The operator touches with his/her finger the panel 1a so as to carry out a point designation. In FIG. 1, a point (hereinafter referred to as a “designated point”) touched by the operator with his/her finger is shown by “P”. By the point designation, the capacitive coupling between the human body and the resistive film is carried out. In FIG. 1, the human body side from the contact point between the human body and the resistive film is shown by an impedance Z. When the operator touches with his/her finger the panel 1a or brings his/her finger close to the panel 1a, a current i1 flows to the observation point A of the panel 101a. Further, the current i2 flows to the observation point B. Further, a current that is a sum of the current i1 and the current i2 flows to the impedance Z. In the present embodiment, an axis obtained by connecting the observation points A and B that are current observation points is a coordinate axis x, and one-dimensional coordinates of the point P is calculated. Regarding the coordinate axis x, a direction from the observation point A toward the observation point B is positive.

FIG. 2 shows the circuit diagram of the touch panel 1 in this case. An in-plane sheet resistance of the resistive film is uniform, a resistance of the resistive film between the points A and B is R, a resistance between the points P and A is R1, and a resistance between the points P and B is R2. In this case, the following formula holds.

[Formula 2]

R=R1+R2

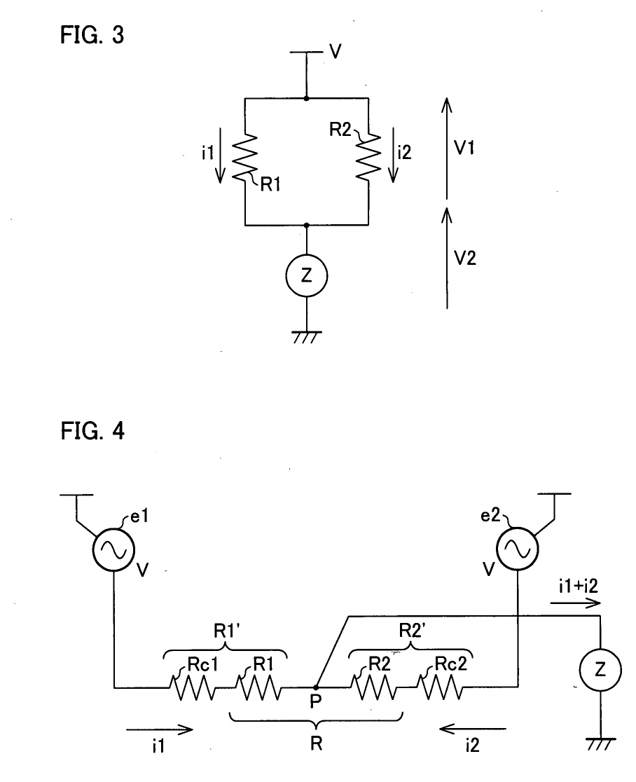

Moreover, FIG. 2 can be redrawn as the equivalent circuit shown in FIG. 3. In FIG. 3, a parallel combined resistance R12 of R1 and R2 is shown by Formula 3 below.

$$R 12 = \frac{R 1 \cdot R 2}{R 1 + R 2} \qquad [ Formula 3 ]$$

### Where a voltage applied to the parallel combined resistance R12 is V1, and a voltage applied to the impedance Z is V2 (=V-V1), Formula 4 below holds.

$$V 1 = V \frac{R 12}{Z + R 12} \qquad [ Formula 4 ]$$

### Therefore, Formula 5 below holds.

$$i 1 = \frac{V 1}{R 1} , i 2 = \frac{V 1}{R 2} \\ \begin{matrix}i 1 = \frac{1}{R 1} \cdot V \frac{R 12}{Z + R 12} = \frac{V}{R 1} \cdot \frac{\frac{R 1 \cdot R 2}{R 1 + R 2}}{Z + \frac{R 1 \cdot R 2}{R 1 + R 2}} \\ = \frac{V}{R 1} \cdot \frac{R 1 \cdot R 2}{Z \cdot R + R 1 \cdot R 2} = \frac{R 2 \cdot V}{Z \cdot R + R 1 \cdot R 2}\end{matrix} \\ i 2 = \frac{R 1 \cdot V}{Z \cdot R + R 1 \cdot R 2} \qquad [ Formula 5 ]$$

### Therefore, Formula 6 holds.

$$\begin{matrix}[ Formula 6 ] & \\ i 1 + i 2 = \frac{V ( R 1 + R 2 )}{Z \cdot R + R 1 \cdot R 2} = \frac{R}{Z \cdot R + R 1 \cdot R 2} V & ( 1 ) \\ i 1 - i 2 = \frac{V \cdot ( R 2 - R 1 )}{Z \cdot R + R 1 \cdot R 2} = \frac{R 2 - R 1}{Z \cdot R + R 1 \cdot R 2} V & ( 2 )\end{matrix}$$

### When Formula (2) is divided by Formula (1), Formula 7 below holds.

$$\begin{matrix}[ Formula 7 ] \\ \frac{i 1 - i 2}{i 1 + i 2} = \frac{R 2 - R 1}{R} = \frac{( R - R 1 ) - R 1}{R} = 1 - \frac{2 R 1}{R}\end{matrix}$$

### Therefore, Formula 8 below is obtained.

$$\begin{matrix}[ Formula 8 ] & \\ \frac{R 1}{R} = \frac{i 2 - i 1}{2 ( i 1 + i 2 )} + \frac{1}{2} & ( 3 )\end{matrix}$$

Since the coordinates of the point P are shown by the ratio of resistances (R1/R), the coordinates of the point P can be obtained by Formula (3) regardless of the impedance Z of the human body. Where the center of a line segment obtained by connecting the points A and B is an origin of coordinates, and the length of the line segment is L, the coordinates of the point P are obtained by Formula 9 below.

$$\begin{matrix}[ Formula 9 ] & \\ x = \frac{L}{2} \cdot \frac{i 2 - i 1}{i 1 + i 2} & ( 4 )\end{matrix}$$

As shown in Formula (4), a coordinate x changes depending only on the current i1 and the current i2. Since the current ii and the current i2 are in phase, it is possible to calculate the ratio of Formula (4) only by detecting the magnitudes of the current i1 and the current i2. Thus, currents used as the numerator of Formula (4) are the current i1 and the current i2. The current i1 and the current i2 are detected at detecting points located respectively on both ends of the coordinate axis. Therefore, the point P is close to either the point A or the point B when the origin is a boundary. As a result, at least one of the current i1 and the current i2 has an adequately large value, and both denominator and numerator of Formula (4) become accurate values. Therefore, it is possible to calculate the coordinate x more accurately than ever before.

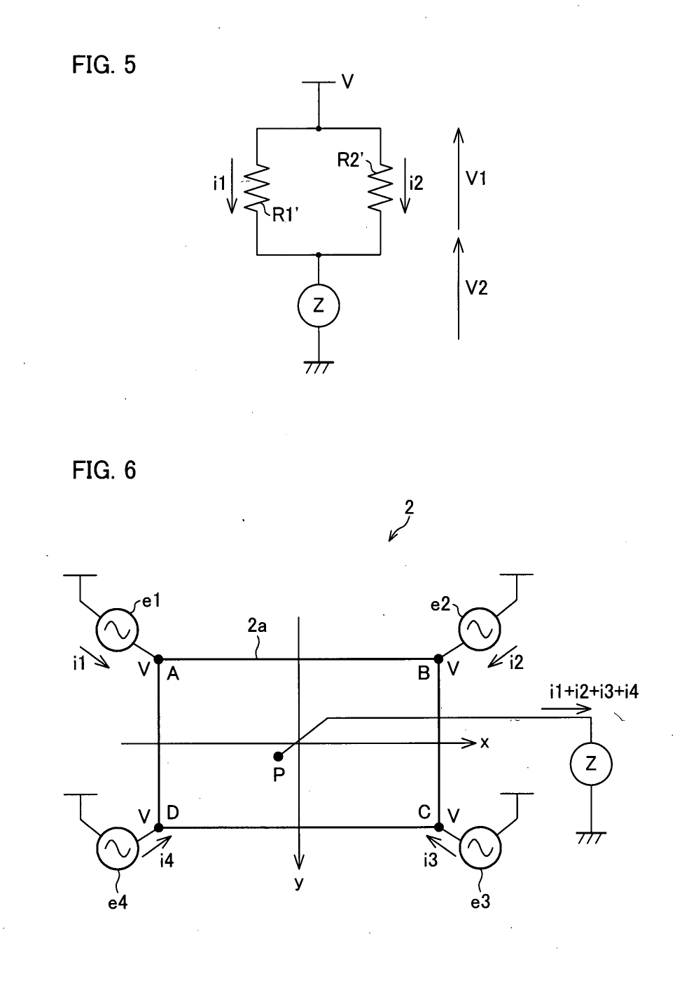

Next, the following will explain how to calculate the coordinate x in a case where there is a wiring resistance, having a significantly large resistance value, in the touch panel 1. In the touch panel 1 shown in FIG. 1, the wiring resistance outside the panel 1a is not considered. If the resistance value of the wiring resistance is adequately small, it is possible to calculate the coordinate x regardless of this wiring resistance. Meanwhile, if the resistance value of the wiring resistance is not adequately small, it is necessary to consider the wiring resistance when calculating the coordinate x. FIG. 4 is a circuit diagram of the touch panel 1 including the wiring resistance having the significantly large resistance value. The wiring resistance on the voltage source e1 side of the point A is Rc1, and the wiring resistance on the voltage source e2 side of the point B is Rc2. Then, an equivalent circuit in which R1′=R1+Rc1 and R2′=R2+Rc2 is shown in FIG. 5. A parallel combined resistance R12′ of R1′ and R2′ is obtained by Formula 10 below.

$$[ Formula 10 ]$$

$$R {12}^{′} = \frac{R {1}^{′} \cdot R {2}^{′}}{R {1}^{′} + R {2}^{′}}$$

### The voltage V1 applied to R12′ is obtained by Formula 11 below.

$$[ Formula 11 ]$$

$$V 1 = V \frac{R {12}^{′}}{Z + R {12}^{′}}$$

### Moreover, Formula 12 below holds.

$$[ Formula 12 ]$$

$$i 1 = \frac{V 1}{R 1} , i 2 = \frac{V 1}{R {2}^{′}}$$

### Therefore, Formula 13 below holds.

$$[ Formula 13 ]$$

$$\begin{matrix}i 1 = \frac{1}{R {1}^{′}} \cdot V \frac{R {12}^{′}}{Z + R {12}^{′}} = \frac{V}{R {1}^{′}} \cdot \frac{\frac{R {1}^{′} \cdot R {2}^{′}}{R {1}^{′} + R {2}^{′}}}{Z + \frac{R {1}^{′} \cdot R {2}^{′}}{R {1}^{′} + R {2}^{′}}} \\ = \frac{V}{R {1}^{′}} \cdot \frac{R {1}^{′} \cdot R {2}^{′}}{Z ( R {1}^{′} + R {2}^{′} ) + R {1}^{′} \cdot R {2}^{′}} \\ = \frac{R {2}^{′} \cdot V}{Z ( R {1}^{′} + R {2}^{′} ) + R {1}^{′} \cdot R {2}^{′}} \\ i 2 = \frac{R {1}^{′} \cdot V}{Z \cdot ( R {1}^{′} + R {2}^{′} ) + R {1}^{′} \cdot R {2}^{′}}\end{matrix}$$

### Therefore, Formula 14 below holds.

$$\begin{matrix}[ Formula 14 ] & \\ i 1 + i 2 = \frac{V ( R {1}^{′} + R {2}^{′} )}{Z ( R {1}^{′} + R {2}^{′} ) + R 1 \cdot R 2} = \frac{( R {1}^{′} + R {2}^{′} )}{Z ( R {1}^{′} + R {2}^{′} ) + R {1}^{′} \cdot R {2}^{′}} V & ( 5 ) \\ \begin{matrix}i 1 - i 2 = \frac{V ( R {2}^{′} - R {1}^{′} )}{Z ( R {1}^{′} + R {2}^{′} ) + R {1}^{′} \cdot R {2}^{′}} \\ = \frac{R {2}^{′} - R {1}^{′}}{Z ( R {1}^{′} + R {2}^{′} ) + R {1}^{′} \cdot R {2}^{′}} V\end{matrix} & ( 6 )\end{matrix}$$

### When Formula (6) is divided by Formula (5), Formula 15 below holds.

$$[ Formula 15 ] \\ \begin{matrix}\begin{matrix}\frac{i 1 - i 2}{i 1 + i 2} = \frac{R {2}^{′} - R {1}^{′}}{R {1}^{′} + R {2}^{′}} = \frac{( R 2 + R c 2 ) - ( R 1 + R c 1 )}{( R 1 + R c 1 + R 2 + R c 2 )} \\ = \frac{R - 2 R 1 + R c 2 - Rc 1}{R + Rc 1 + Rc 2} \\ = \frac{R + Rc 1 + Rc 2 - 2 R 1 - 2 Rc 1}{R + R c 1 + R c 2} \\ = 1 - \frac{2 ( R 1 + Rc 1 )}{R + Rc 1 + Rc 2}\end{matrix} & \end{matrix} \qquad$$

### Therefore, Formula 16 below is obtained.

$$\begin{matrix}[ Formula 16 ] & \\ \frac{R 1 + Rc 1}{R + Rc 1 + Rc 2} = \frac{i 2 - i 1}{2 ( i 1 + i 2 )} + \frac{1}{2} & ( 7 ) \\ \frac{R 1}{R} = \frac{i 2 - i 1}{2 ( i 1 + i 2 )} + \frac{1}{2} - \frac{R c 1}{R} & {( 7 )}^{′}\end{matrix}$$

### Here, the wiring resistance Rc1<<R, and the wiring resistance Rc2<<R.

As shown in Formula (7), when the resistance R1 is small, the resistance value of the wiring resistance Rc1 is unignorable. This indicates that the coordinate x deviates from the ideal value obtained by Formula (4) which does not consider the wiring resistance. Therefore, when the wiring resistance is unignorable, Formula (4) is corrected in light of Formula (7)′. Thus, it is possible to calculate the coordinate x when there are the wiring resistances Rc1 and Rc2.

As above, according to the present embodiment, when detecting the coordinates of the point P on the panel 1a, the coordinate axis set on the panel 1a is first formed by connecting two points that are the current observation points A and B. Then, the coordinate component of the coordinate axis x is detected only by the currents i1 and i2 respectively flowing through the current observation points A and B located respectively on both ends of the coordinate axis x. The magnitude of the current i1 (i2) of the current observation point A (B) corresponds to a distance between the point P and the current observation point A (B). In addition, even when the component of the point P on the coordinate axis x changes, the point P gets away from one of the current observation points A and B located respectively on both ends of the coordinate axis x in light of the coordinate axis x direction, and gets close to the other one. Therefore, at least one of the currents i1 and i2 is adequately large in magnitude. Therefore, it is possible to accurately calculate the component of the point P on the coordinate axis x

Thus, it is possible to carry out the coordinate detection accurately in a wide range of the panel 1a of the touch panel 1.

Moreover, according to the present embodiment, since the in-plane sheet resistance of the resistive film is uniform, in the case of designating the center of the panel, the numerator of Formula 4 is i1=i2, that is, O. Therefore, the component of the designated point P on the coordinate axis x is stable regardless of variations of the resistor. Even when the wiring resistance is unignorable, by setting the wiring resistance Rc1<<R and the wiring resistance Rc2<<R, the error is L*Rc1/R, that is Rc1<<R by Formula (7)′. Therefore, the error is almost ignorable. This means that not only the origin of coordinates is easily determined in the same panel 1a but also the difference due to the production tolerance of the touch panel 1, represented by the panel 1a, is absorbed. That is, the position of the center is stable even if the resistance of the resistor and/or the wiring resistance are/is produced between different devices. Therefore, the center of the coordinates is stable not only in the same device but also between different devices.

The above formulas are approximation formulas that are very close to ideal, but are reflecting actual measurement values highly accurately. The difference between the coefficient value and the ideal value can easily be calibrated by measuring current values of plural points each of whose coordinates have been identified.

### Embodiment 2

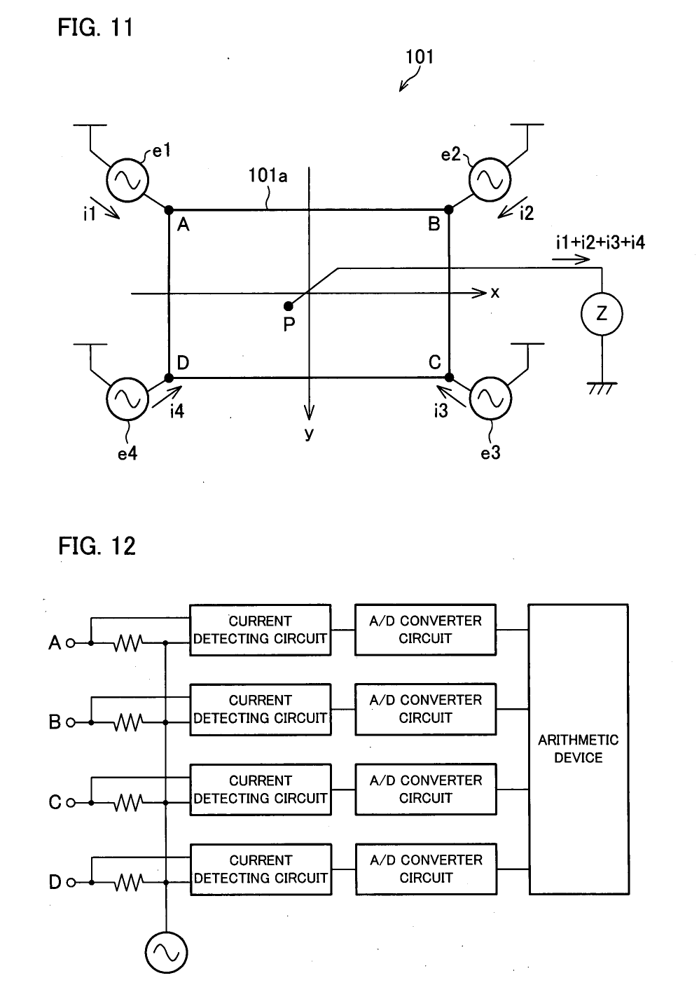

The following will explain another embodiment of the present invention on the basis of FIGS. 6 to 11.

FIG. 6 shows an arrangement of a touch panel 2 that is a coordinate detecting apparatus of the present embodiment. The touch panel 2 is a capacitive coupling touch panel, and includes a rectangular panel 2a. Current observation points A to D located respectively at four corners of an end portion of the panel 2a are connected respectively to voltage sources e1 to e4 each of which generates an alternating voltage V. The magnitudes, frequencies and phases of the voltages V of the voltage sources e1 to e4 are equal to each other.

As with the above-described panel 101a shown in FIG. 12, the panel 1a is configured such that (i) a glass substrate or a film substrate is provided on an upper surface of a display device, such as a liquid crystal display apparatus, a CRT, an organic EL display apparatus, or a plasma display panel, (ii) a resistive film, such as a transparent ITO (Indium Tin Oxide) film or a NESA (tin oxide) film, is formed as a surface resistor on the glass substrate or the film substrate, (iii) a low resistant resistor is provided so as to surround the resistive film, and (iv) a protective film, such as PET, TAC, or glass, is provided on upper surfaces of the resistive film and the low resistant resistor. The film substrate or the -glass substrate on which the surface resistor is formed may also function as a front surface substrate of the display device. Moreover, in the case of not using the display apparatus, it is possible to use, for example, an opaque carbon film as the resistive film. Moreover, in the present example, the protective film is provided on the front surface of the resistive film, but the protective film is not essential. Moreover, by providing the resistive film on the display apparatus and then providing the glass substrate or the film substrate on the resistive film, the substrate may also function as a protective layer.

Regarding the resistive film which is in the shape of an actual rectangle or a pseudo rectangle, since the film surface at the peripheral portion of the resistive film cannot be regarded as an infinite flat surface, the current distribution at the peripheral portion gets uneven. The present invention effectively functions even in this state. However, to ease the unevenness of the current distribution at the peripheral portion, the low resistant resistor is provided at the peripheral portion as shown in FIG. 10. Thus, influence of the edge of the resistive film is reduced, and this makes it possible to more effectively detect the coordinates in a wide range highly accurately. In the present example, the surface resistance value of the resistive film is set to about 1 kΩ/□, and the resistivity of the low resistant resistor at the peripheral portion is set to about 6 106 /□.

The operator touches with his/her finger the panel 2a so as to carry out the point designation. In FIG. 6, the designated point is shown as the designated point P. By the point designation, the capacitive coupling between the panel 2a and the human body is carried out. In FIG. 6, the human body is shown by the impedance Z. With this, the current i1 flows to a current observation point A of the panel 2a, the current i2 flows to a current observation point B of the panel 2a, the current 13 flows to a current observation point C of the panel 2a, and the current I4 flows to a current observation point D of the panel 2a. Further, a current that is a sum of the currents i1 to i4 flows to the impedance Z.

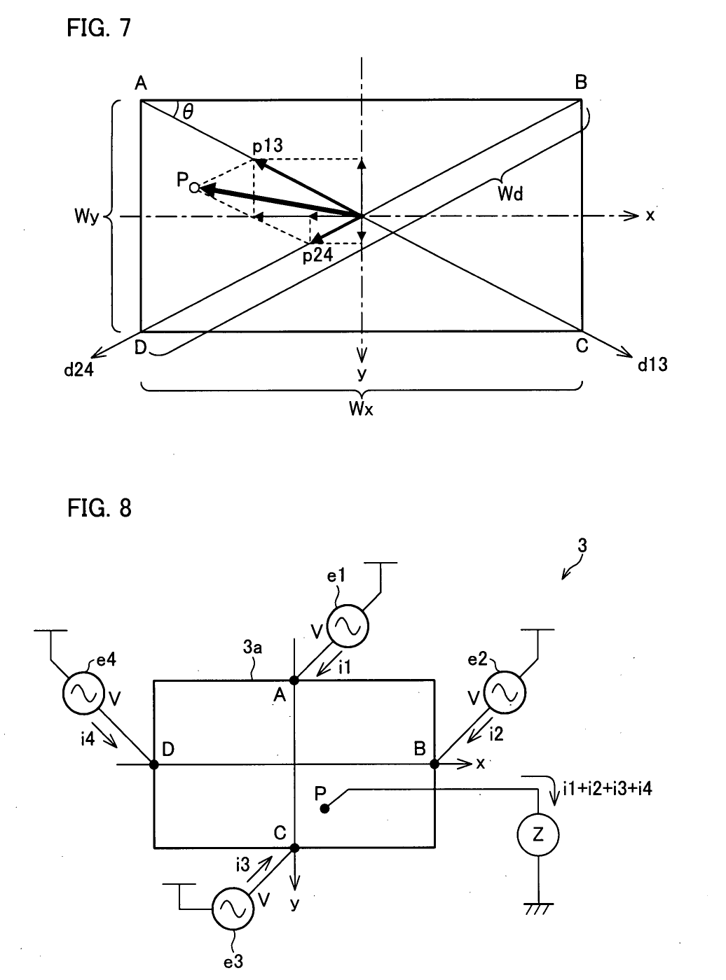

In the present embodiment, as shown in FIG. 7, a diagonal axis obtained by connecting the current observation points A and C is a coordinate axis d13, and a diagonal axis obtained by connecting the current observation points B and D is a coordinate axis d24. First, the coordinates of the designated point P are obtained as the coordinates of these two axes. Next, the coordinates of the above two axis are converted into a horizontal coordinate value x and a vertical coordinate value y which are convenient in the panel 2a. Note that an origin obtained by the coordinate axes d13 and d24 is located on the center of the panel 2a, and is identical with an origin obtained by the coordinate axes x and y. Regarding the coordinate axis d13, a direction from the current observation point A toward the current observation point C is positive. Regarding the coordinate axis d24, a direction from the current observation point B toward the current observation point D is positive. Regarding the coordinate axis x, a direction from a side AD toward a side BC is positive. Regarding the coordinate axis y, a direction from a side AB toward a side DC is positive. Moreover, the in-plane sheet resistance of the resistive film is uniform.

According to the present invention, as shown in FIG. 7, a coordinate vector of the point P on the panel 2a can be calculated as a vector sum of a coordinate vector of a calculated point p13 on the coordinate axis d13 and a coordinate vector on the coordinate axis d24.

That is, as shown in FIG. 7, two-dimensional rectangular coordinates x and y on the panel 2a can be calculated respectively as a sum of the x component of the coordinate axis d13 and the x component of the coordinate axis d24 and a sum of the y component of the coordinate axis d13 and the y component of the coordinate axis d24. Thus, Formula 17 below holds.

$$\begin{matrix}[ Formula 17 ] & \\ p 13 = K 13 \frac{i 3 - i 1}{i 1 + i 3} & ( 8 ) \\ p 24 = K 24 \frac{i 4 - i 2}{i 2 + i 4} & ( 9 )\end{matrix}$$

### Note that K13 and K24 are constants.

The coordinates x and y are represented respectively by a sum of horizontal components of p13 and p24 and a sum of vertical components of p13 and p24. The panel 2a is rectangular, the length of each of the side AB and the side DC is Wx, the length of each of the side AD and the side BC is Wy, and the length of each of a diagonal line AC and a diagonal line BD is Wd. Moreover, each of an angle between the coordinate axis d13 and the coordinate axis x and an angle between the coordinate axis d24 and the coordinate axis x is θ (O≦θ≦π/2). Here, Formula 18 below holds.

$$\begin{matrix}[ Formula 18 ] & \\ \begin{matrix}x = p 13 \cdot cos θ - p 24 \cdot cos θ \\ = cos θ ( K 13 \frac{i 3 - i 1}{i 1 + i 3} - K 24 \frac{i 4 - i 2}{i 2 + i 4} ) \\ = \frac{Wx}{Wd} ( K 13 \frac{i 3 - i 1}{i 1 + i 3} - K 24 \frac{i 4 - i 2}{i 2 + i 4} )\end{matrix} & ( 10 ) \\ \begin{matrix}y = p 13 \cdot sin θ + p 24 \cdot sin θ \\ = sin θ ( K 13 \frac{i 3 - i 1}{i 1 + i 3} + K 24 \frac{i 4 - i 2}{i 2 + i 4} ) \\ = \frac{Wy}{Wd} ( K 13 \frac{i 3 - i 1}{i 1 + i 3} + K 24 \frac{i 4 - i 2}{i 2 + i 4} )\end{matrix} & ( 11 )\end{matrix}$$

Since the in-plane resistance of the resistive film is uniform, K13 is equal to K24 (K13=K24). Therefore, Formula 19 below holds.

$$\begin{matrix}[ Formula 19 ] & \\ \begin{matrix}x = \frac{Wx}{Wd} ( K 13 \frac{i 3 - i 1}{i 1 + i 3} - K 24 \frac{i 4 - i 2}{i 2 + i 4} ) \\ = K 13 \frac{Wx}{Wd} ( \frac{i 3 - i 1}{i 1 + i 3} - \frac{i 4 - i 2}{i 2 + i 4} ) \\ = Kx ( \frac{i 3 - i 1}{i 1 + i 3} - \frac{i 4 - i 2}{i 2 + i 4} )\end{matrix} & ( 12 ) \\ \begin{matrix}y = \frac{Wy}{Wd} ( K 13 \frac{i 3 - i 1}{i 1 + i 3} + K 24 \frac{i 4 - i 2}{i 2 + i 4} ) \\ = K 13 \frac{Wy}{Wd} ( \frac{i 3 - i 1}{i 1 + i 3} + \frac{i 4 - i 2}{i 2 + i 4} ) \\ = Ky ( \frac{i 3 - i 1}{i 1 + i 3} + \frac{i 4 - i 2}{i 2 + i 4} )\end{matrix} \\ Kx = K 13 \frac{Wx}{Wd} = \frac{Wx}{2} , Ky = K 13 \frac{Wy}{Wd} = \frac{Wy}{2} & ( 13 )\end{matrix}$$

Generally, Formula 20 below holds.

$$\begin{matrix}[ Formula 20 ] & \\ x = Cx + Kx ( \frac{i 1 - i 3}{i 1 + i 3} - \frac{i 2 - i 4}{i 2 + i 4} ) & ( 14 ) \\ y = Cy + Ky ( \frac{i 1 - i 3}{i 1 + i 3} + \frac{i 2 - i 4}{i 2 + i 4} ) & ( 15 )\end{matrix}$$

With this, it is possible to highly accurately calculate the two-dimensional coordinates in a panel which is in the shape of a rectangular or a pseudo rectangular.

Next, the following will explain an arrangement in which the current observation points A to D are not located on four corners of a panel. The current observation points may not be connected to the four corners of the panel. As with the panel 2a, a panel 3a of a touch panel 3 shown in FIG. 8 is a rectangular panel, but the current observation points A to D are located respectively on vicinities of centers of four sides of an end portion of the panel. Accordingly, the voltage sources e1 to e4 are connected respectively to the current observation points A to D. In this case, as with the panel 2a, it is possible to detect the coordinates x and y of the two-dimensional rectangular coordinate system. In the present example, an axis obtained by connecting the current observation points D and B is a coordinate axis BD, and an axis obtained by connecting the current observation points A and C is a coordinate axis AC. In this case, since an angle between the coordinate axis x and the coordinate axis AC is O, and an angle between the coordinate axis BD and the coordinate axis x is π/2, the x component of the coordinate axis AC is equal to the coordinate of the coordinate axis AC, and the x component of the coordinate axis BD is O. Therefore, since the coordinate of the designated point on the coordinate axis x is equal to the detected coordinate on the coordinate axis AC, it is possible to detect the coordinate value on the x-axis only by two coordinates of two points that are the current observation point A and the current observation point C. Similarly, since the coordinate of the coordinate axis y is equal to the detected value on the coordinate axis BD, it is possible to detect the coordinate value on the y-axis only by the currents of two points that are the current observation points B and D. Therefore, according to the touch panel of the present arrangement, it is possible to simplify the arrangement for the coordinate calculation.

Moreover, in the coordinate detecting apparatus of the present arrangement, two axes which are orthogonal to each other are located on the center of a screen. Therefore, there is no point which is far away from the coordinate axis. Thus, the accuracy improves.

Next, the following will explain an arrangement in which the coordinate calculation is carried out by using three of the current observation points. The coordinate detecting apparatus of this arrangement is explained in reference to FIG. 6. According to the present arrangement, the coordinates are detected using three points A to C out of the coordinate observation points A to D shown in FIG. 6 and also using, as two axes of a coordinate calculation scheme of the present invention, a coordinate axis obtained by connecting the coordinate observation points A and B and a coordinate axis obtained by connecting the coordinate observation points B and C. Even in the case of setting the coordinate axes as above, each coordinate axis component of the designated point P is calculated only by using the currents flowing respectively to the current observation points provided respectively at both ends of each coordinate axis out of the currents flowing respectively to the four current observation points. Therefore, the effects of the present invention do not disappear. On this account, it is possible to calculate the coordinates even at the periphery more accurately than conventional schemes. Moreover, in the present arrangement, since the coordinate observation point B is used mutually, it is not necessary to detect the current value of the current observation point D which does not relate to the coordinate detection. Therefore, the current detection is unnecessary, and the arrangements of the current detecting section and a coordinate detecting section are simplified.

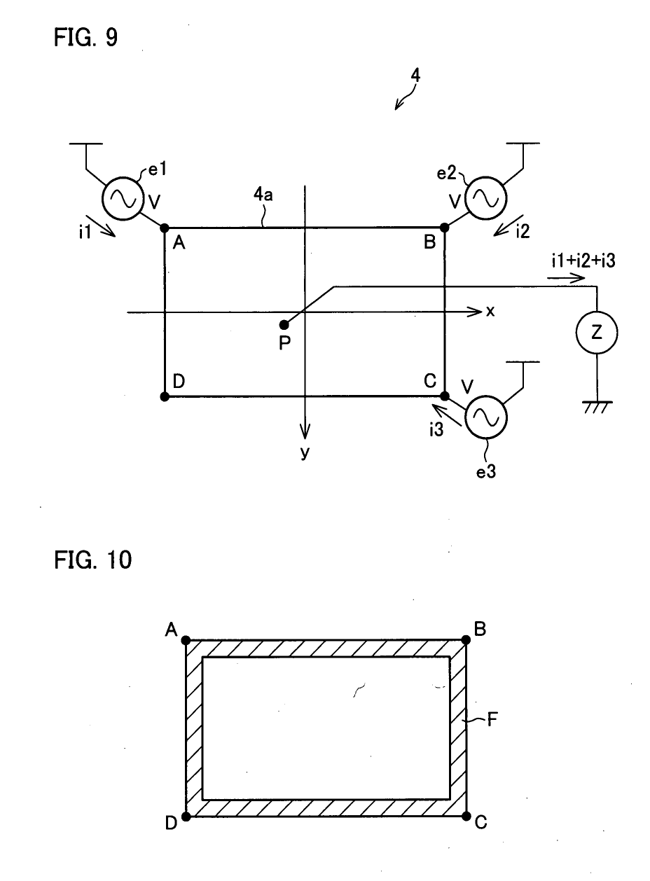

Moreover, in a case where, as in the touch panel of the present arrangement, one current observation point is shared by two axes, and the coordinates of the designated point P are calculated by the currents of three current observation points, the coordinates can be calculated in such a manner that, as in the touch panel 4 shown in FIG. 9, a voltage source is not connected to one of four corners of the panel 4a (for example, the peak D), and the voltage sources e1 to e3 are connected respectively to the remaining three current observation points A to C. In this case, a sum of the currents i1, i2 and i3 flows to the impedance Z. According to the present arrangement, the current flowing to the peak D is divided proportionately for the current observation points A to C. Therefore, although the accuracy of this case is lower than a case where the voltage source is connected to the current observation point D, it is possible to simplify the arrangement (for example, reduction in the number of voltage sources), simplify the arrangement for the current detection, and narrow a frame by reduction in the number of wirings.

Next, the following will explain a method for calculating a current, detected by the current detecting section, using a general-purpose arithmetic circuit, such as a CPU device as coordinate calculating means.

FIG. 12 is a block diagram showing current detecting circuits and an arithmetic section of the touch panel of the present arrangement. Inputs of the current detecting circuits shown in FIG. 12 are connected respectively to the current observation points A to D located respectively on four peaks of the rectangular touch panel explained in Embodiment 2. Outputs of the current detecting circuits are connected to an input terminal of an arithmetic device via A/D converter circuits. A single voltage source is connected to the current observation points A to D, and it applies the same voltages of the same phases to the current observation points A to D, respectively. When the operator touches with his/her finger the touch panel and designates coordinates, currents flow to the current observation points A to D. The current detecting circuit amplifies the current generated on the coordinate observation point by the coordinate designation on the touch panel by the operator, and converts the current to the voltage value corresponding to the amount of current. The voltage value output from the current detecting circuit is converted by the A/D converter circuit into a digital value corresponding to the voltage value, and is output to an input port of the arithmetic device. As the arithmetic device, it is possible to use a general-purpose arithmetic device, such as a microprocessor. Moreover, as the A/D converter circuit, it is possible to use a circuit containing a microprocessor.

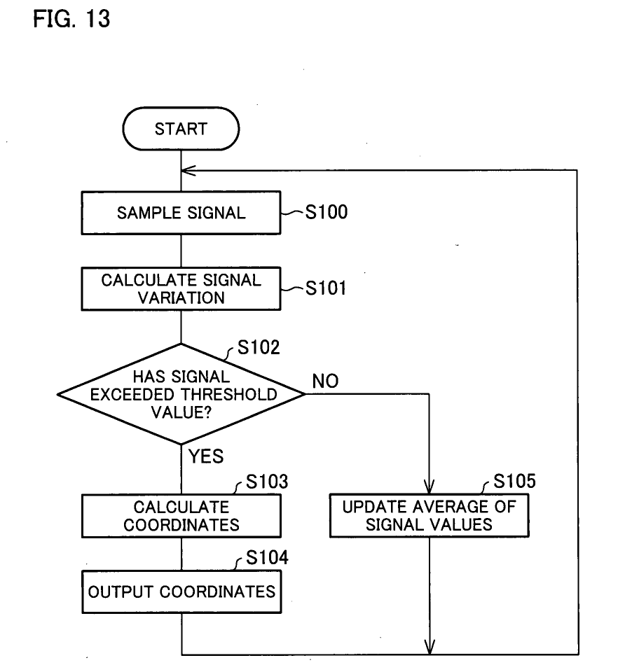

Referring to the flow chart of FIG. 13, the following will explain a procedure of the arithmetic device calculating the coordinates of a point designated by the operator. The arithmetic device samples data of the input port, and obtains a value corresponding to the amount of current of each of the current observation points A to D (Step S100). The current value of the touch panel is converted by the current detecting circuit into a voltage difference from a steady voltage. The arithmetic device obtains a difference between a newest sampling value and the steady voltage so as to calculate a signal variation (Step S101). Thus, it is possible to obtain a value proportional to the current value of the touch panel. The steady voltage value may be a fixed value. However, to avoid changes due to variations of the circuit, the temperature, and/or the like, it is desirable to update the steady voltage value as needed. Moreover, when updating, to avoid influences of noises and/or changes occurred immediately before touching, it is desirable to determine the steady voltage value by carrying out averaging more than once. The steady voltage value may be updated only at the time of start-up in a case where changes due to time do not matter, such as a case where changes after the power source is turned on or changes due to the temperature hardly occur, or a case where an operating time is short.

When the current flows to the current observation point by the coordinate designation of the operator, the value input to the arithmetic device increases in accordance with the current value. Therefore, the arithmetic device sets a constant threshold value, and determines whether or not the signal variation that is the difference value has exceeded this threshold value, so as to determine whether or not touching is carried out (Step S102). The determination regarding the threshold value may be carried out for at least one terminal. However, to avoid erroneous determination due to noises, etc., it is desirable to carry out the determination for a plurality of terminals. When the signal variation exceeds the threshold value, the processing proceeds to Step S103. Meanwhile, when the signal variation does not exceed the threshold value, the processing proceeds to Step S105.

When the signal variation has exceeded the threshold value, the arithmetic device calculates the coordinates using Formulas 14 and 15 (Step S103). Then, the arithmetic device outputs the calculated coordinates outside (Step S104). Then, the processing returns to Step S100.

When the signal variation has not exceeded the threshold value, there is no input. Therefore, the arithmetic device updates the steady voltage value (Step S105). Then, the processing returns to Step S100. In the present processing, when the signal variation has not exceeded the threshold value, the steady voltage is updated every time. However, it is not necessary to update the steady voltage every time. The steady voltage may be updated periodically, or it may be updated when there is no input for a certain period of time.

The embodiments are described as above. In each embodiment, the point designation on the panel is carried out by touching it with the finger of the operator. However, the present invention is not limited to this, and the point designation may be carried out by the approach or contact of a conductive indicating device, such as a conductive stylus pen.

Moreover, the indicating device is not limited to a pen shape, and the point designation may be carried out as follows: a conductive film is provided above the upper surface of the surface resistor with a space therebetween; the conductive film and the surface resistor contact each other by the contact of the finger, the pen, or the like; the current flows between the conductive film and the surface resistor at the contact point.

Moreover, in addition to the point designation by the contacting, a coordinate detecting apparatus and a coordinate detecting method in each of which the current flowing to the current observation point by the electric charge transfer at the designated point changes in accordance with the position of the designated point are included within the scope of the present invention (for example, the point designation by the light irradiation in the above-described PSD (semiconductor optical position detecting device)). Moreover, in the case of not providing the display apparatus at the bottom of the coordinate detecting apparatus, the resistive film does not have to be transparent, and may be a light shielding film, such as a carbon film.

Moreover, the shape of the panel does not have to be a perfect rectangle shown in FIG. 1. To avoid influence of the peripheral portion of the panel, the present invention is applicable to a pseudo touch panel whose periphery is bend in the shape of a concave parabola. Moreover, to avoid the influence of the peripheral portion of the panel, or to meet a design requirement, the present invention is applicable to a pseudo rectangular panel whose at least one side of the peripheral portion is bent.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be preferably used for a coordinate detecting apparatus, such as a touch sensor, a touch panel, a tablet, a digitizer, and PSD, and for a coordinate calculating method using the coordinate detecting apparatus.

1. A coordinate detecting apparatus which detects a position of a point on a panel which point is designated by an operator, the coordinate detecting apparatus comprising:
a surface resistor which is provided on the panel and has a substantially rectangular shape;
a plurality of current detecting means, connected respectively to connection points of an outer peripheral portion of the surface resistor, for detecting currents flowing through the connection points; and
coordinate calculating means for, based on values of currents flowing through two of the current detecting means which are connected respectively to two connection points provided respectively on two sides of the outer peripheral portion of the surface resistor which two sides face each other, calculating a coordinate component of the designated point on an axis obtained by connecting the two connection points on the surface resistor.

2. The coordinate detecting apparatus as set forth in claim 1, wherein:
the plurality of the current detecting means are first, second, third and fourth current detecting means connected respectively to the connection points provided on four sides of the outer peripheral portion of the surface resistor; and
based on (i) a current detected by the first current detecting means connected to one of two connection points provided respectively on two sides of the outer peripheral portion of the surface resistor which two sides face each other and (ii) a current detected by the second current detecting means connected to the other connection point, the coordinate calculating means calculates a first coordinate component of the designated point on a first axis obtained by connecting the two connection points, and based on (i) a current detected by the third current detecting means connected to one of two connection points provided respectively on the other two sides of the outer peripheral portion of the surface resistor which two sides face each other and (ii) a current detected by the fourth current detecting means connected to the other connection point, the coordinate calculating means calculates a second coordinate component of the designated point on a second axis obtained by connecting the two connection points.

3. The coordinate detecting apparatus as set forth in claim 2, wherein:
the coordinate calculating means assumes two-dimensional output coordinate axes on the surface resistor, a sum of (i) a coordinate component, on one of the output coordinate axes, of the first coordinate component of the designated point and (ii) a coordinate component, on said one of the output coordinate axes, of the second coordinate component of the designated point is a coordinate component on said one of the output coordinate axes, and a sum of (i) a coordinate component, on the other output coordinate axis, of the first coordinate component of the designated point and (ii) a coordinate component, on the other coordinate axis, of the second coordinate component of the designated point is a coordinate component on the other output coordinate axis.

4. The coordinate detecting apparatus as set forth in claim 2, wherein the first, second, third and fourth current detecting sections are connected respectively to the connection points at four peaks of the surface resistor.

5. The coordinate detecting apparatus as set forth in claim 4, wherein the coordinate calculating means assumes a two-dimensional rectangular output coordinate system on the surface resistor, and calculates coordinates, on the two-dimensional rectangular output coordinate system, of the designated point based on the first coordinate component and the second coordinate component.

6. The coordinate detecting apparatus as set forth in claim 2, wherein the first, second, third and fourth current detecting means are connected respectively to the connection points each located on a vicinity of a median point of each of the four sides of the outer peripheral portion of the surface resistor.

7. The coordinate detecting apparatus as set forth in claim 1, wherein:
the plurality of the current detecting means are first, second and third current detecting means connected respectively to the connection points provided at three of four peaks of the surface resistor; and
based on the first current detecting means and the second current detecting means which are connected respectively to two connection points provided respectively at both ends of one side of the outer peripheral portion of the surface resistor, the coordinate calculating means calculates a first coordinate component of the designated point on a first axis obtained by connecting the two connection points, and based on the first current detecting means and the third current detecting means which are connected respectively to two connection point provided respectively at both ends of the other side adjacent to said one side of the outer peripheral portion of the surface resistor, the coordinate calculating means calculates a second coordinate component of the designated point on a second axis obtained by connecting the two connection points.

8. The coordinate detecting apparatus as set forth in claim 1, further comprising a resistor which is provided around the surface resistor, and has a resistance value lower than a surface resistance value of the surface resistor.

9. The coordinate detecting apparatus as set forth in claim 1, wherein the current flowing through the connection point of the surface resistor is a current by transfer of electric charge generated by light irradiation.

10. A display apparatus, comprising a coordinate detecting apparatus which detects a position of a point on a panel which point is designated by an operator, the coordinate detecting apparatus comprising:
a surface resistor which is provided on the panel and has a substantially rectangular shape;
a plurality of current detecting means, connected respectively to connection points of an outer peripheral portion of the surface resistor, for detecting currents flowing through the connection points; and
coordinate calculating means for, based on values of currents flowing through two of the current detecting means which are connected respectively to two connection points provided respectively on two sides of the outer peripheral portion of the surface resistor which two sides face each other, calculating a coordinate component of the designated point on an axis obtained by connecting the two connection points on the surface resistor.

11. A method for detecting coordinates of a designated point, the method being used by a coordinate detecting apparatus including: a surface resistor having a substantially rectangular shape; and a plurality of current detecting means which are connected respectively to connection points provided at an end portion of the surface resistor, and through each of which, when a point is designated on the surface resistor, a current corresponding to a distance between the connection point and the point flows,
the method comprising the steps of:
detecting, when an operator designates a point on the surface resistor, values of currents flowing through two connection points which are provided respectively on two sides of the outer peripheral portion of the surface resistor which two sides face each other; and
calculating, based on the two values of currents detected in the detecting step, a coordinate component of the designated point on an axis obtained by connecting the two connection points.
